(19) United States
(12) Patent Application Publication
(10) Pub. No.: US 2010/0130224 A1
(43) Pub. Date: May 27, 2010

(54) WIRELESS COMMUNICATION DEVICE, WIRELESS COMMUNICATION SYSTEM AND METHOD OF WIRELESS COMMUNICATION

(76) Inventors: Kentaro ISHIZU, Tokyo (JP); Homare Murakami, Tokyo (JP); Goh Miyamoto, Tokyo (JP); Ha Nguyen Tran, Tokyo (JP); Stanislav Filin, Tokyo (JP); Hiroshi Harada, Tokyo (JP)

Correspondence Address: ABELMAN, FRAYNE & SCHWAB, 666 THIRD AVENUE, 10TH FLOOR, NEW YORK, NY, 10017, US

(21) Appl. No.: 12/625,243

(22) Filed: Nov. 24, 2009

(30) Foreign Application Priority Data
Nov. 25, 2008 (JP) 2008-299261

(51) Int. Cl. H04W 72/04

(52) U.S. Cl. 455/453

(57) ABSTRACT

A method in which communication quality of a base station is accumulated according to type of an application and when a communication terminal device switches a base station, an optimal base station for each application is selected is provided. A wireless communication device of the present invention is provided with priority notifying means storing priority information of communication conducted by the local device and notifying it to the other wireless communication devices so that the priority can be notified to the outside. A priority information collecting means collects the priority information notified by the other devices, and a priority information comparing means compares the priority information of the local device with the collected priority information. Wireless communication control means is provided so that as the result of comparison, if the priority of the other devices is higher than the priority of the local device, the wireless communication means is controlled.

### CROSS-REFERENCE TO RELATED APPLICATIONS

This application is related to and claims priority under 35 USC §119(a) to Japanese Patent Application 2008-299261 filed on Nov. 25, 2008 which is incorporated by reference herein.

### BACKGROUND OF THE INVENTION

1. Field of the Invention

The present invention relates to a wireless communication device and a wireless communication system, and a method of wireless communication and particularly relates to a technique for effectively using frequency resources by adjusting an operation mode of wireless communication between the wireless communication devices.

2. Description of the Related Art

Effective use of frequency resources is in demand as a result of the rapid spread of wireless communication systems. For example, with a link aggregation technique in which high-speed communication is performed by bundling a plurality of frequency channels, as number of usable channels increases, the communication speed also increases.

However, use of the frequency resources is exclusive, and in the case of simultaneous use by a large number of people or use in a mode to occupy many channels, there are problems that a communication quality might be lowered or the communication becomes impossible. Particularly, the frequency resources might fall short at an event venue where many users gather or at an evacuation site at the time of disaster, and there is a fear that important communications could fail.

As a technique for effectively using the frequency resources, a specification is being prepared by IEEE802.22. Briefly, this specification provides that in the event television broadcasting is not in service at a position where a terminal is currently located, the terminal performs data communication or the like temporarily using as its frequency a television broadcasting frequency. A database having accurate position information of base stations is used for this purpose. According to this specification, a network centralized control type access-right management is carried out using a server and a database.

Also, another proposed solution currently being examined in its research stage involves wireless access using two priorities, that is, primary and secondary. However, in an actual use environment, sufficient effects cannot be obtained unless the priorities are set in more stages such as voice communication at a disaster, public-administration data communication, mobile phone voice communication, internet data communication and the like. Moreover, as can be seen from the example of television broadcasting, the priority is also changed by the existence or non-existence of other types of communication, and accordingly a system should have the capability to evaluate relative priorities.

In the previously proposed patent documents, many techniques having the purpose of effective use of frequency resources include those logically dividing mainly a single frequency channel and fairly distributing it. Also, there is such a technique that traffic is balanced so that a line of each base station can be effectively used.

The technique in Japanese Patent Laid-Open No. 2001-054164 proposes a base station device with line connection control means that determines if a line state is saturated or not on the basis of the number of currently communicating users. If the line state is saturated, the means selects users allowed to connect to the line or to use high-speed communication based on the priority of the users. According to this technique, communication for users with high priority can be ensured, but this is a method only effective if the provider and the users are under a single management regime. That is, priority should be determined in advance among the users, and accordingly this technique differentiates users mainly based upon communication service contracts.

Also, a technique proposed in Japanese Patent Laid-Open No. 2002-204478 discloses a centralized control of on/off functions of a plurality of base stations. This technique is intended to reduce wasted transmission power for base stations if communication traffic is low in a system in which a single area is covered by a plurality of base stations. The discloses system is provided with a state monitoring means for monitoring states of the plurality of base stations and a control means for controlling on/off operations of each base station based on a monitoring result.

The technique of Japanese Patent Laid-Open No. 2002-204478 is to suppress power while not in use and cannot control communication between the base stations when the traffic level is large. Therefore, this technique does not contribute to effective use of the frequency resources.

However, apart from a case in which a specific operator performs communication in their own network only, such a technique is not known whereby communications with high priority are ensured by a general-purpose control on the base station side, if the traffic by plural base stations becomes excessive in the same area.

### SUMMARY OF THE INVENTION

In any of the above-mentioned techniques, a technique to promote effective use of the frequency resources by relatively grasping communication priorities between base stations is not provided.

In order to solve the problems of the prior art techniques, the present invention provides a technique to ensure communication with high priority through autonomous control on the base station side and to effectively distribute frequency resources so that communication with low priority can also be enabled as much as possible.

In order to solve the above problems, the present invention provides a wireless communication device used for communication through a wireless communication network as follows. The device is provided with a wireless communication means and with a priority information memory means for storing priority information on communication conducted by the local device. The device further includes a priority notification means for notifying the priority information to other wireless communication devices so that the priority can be notified to the outside.

Further, a priority information collecting means is provided for collecting the priority information notified by other wireless communication devices (other devices) conducting wireless communication, and a priority information comparing means is provided for comparing the priority information of the local device and the collected priority information of the other devices, so as to compare whether the wireless communication of the local device or that of the other devices is given priority.

A wireless communication control means is also provided so that, as the result of comparison, if the priority of other devices is higher than the priority of the local device, control is executed so that the wireless communication means is brought to non-operation or to a communication state with a low load.

In the above-mentioned wireless communication device, the priority information may be provided with condition information relating to the priority so that the priority information comparing means can compare the priority information on the basis of satisfaction or not of a condition according to the condition information. Here, the priorities may be defined according to frequency using the frequency for performing the wireless communication as the conditions.

Alternatively, a clocking means may be provided in the wireless communication device so that time information such as date, time, day of the week, operation lasting time and the like can be used as the condition information. Other arbitrary conditions such as a location of the wireless communication device can be used.

The above-mentioned priority notification means may be configured such that the priority information is notified to the priority information collecting means of the other devices using a wireless or wired communication network. Particularly, it may be so configured that the priority information is notified to the priority information collecting means of the other devices using the same wireless communication means as those used by the priority notification means for communication through the wireless communication network. It may be so configured that the above-mentioned priority notification means notifies the priority information by adding it to a data frame transmitted from the wireless communication means, while the priority information collecting means receives the data frame transmitted from the wireless communication means of the other devices and extracts the priority information.

In another embodiment, the present invention provides a wireless communication system including a wireless communication network and a plurality of wireless communication devices. The wireless communication devices of this system are provided with, similar to the above, wireless communication means, priority information memory means, priority notification means, priority information collecting means, priority information comparing means, and wireless communication control means, respectively. If, as the result of comparison processing by the priority information comparing means, the priority of the other devices is higher than the priority of the local device, the wireless communication control means controls the wireless communication means to non-operation or to a communication state with a low load.

In the wireless communication system, apart from the plurality of wireless communication devices, a priority information relay server may be provided. The server collects the priority information from the priority notification means provided in the plurality of wireless communication devices and notifies the collected priority information to the plurality of wireless communication devices. Any one of the wireless communication devices may also act as the priority information relay server.

In the configuration in which the wireless communication devices directly exchange priority information or in the configuration in which the priority information relay server is used, it may be so configured that the priority information is notified to the priority information collecting means of the other devices through the wireless communication network using the same wireless communication means as that used by the priority notification means.

The present invention can also provide as a wireless communication method which can adjust an operation mode of the wireless communication performed by each device between the wireless communication devices in the above-mentioned wireless communication system. This processing method is characterized in that the priority information of the communication performed by the local device is stored in the wireless communication device in advance and the following steps are provided:

(S1) Priority notification step in which the priority notification means notifies the priority information of the local device to the other wireless communication devices at a predetermined trigger;

(S2) Priority information collecting step in which the priority information collecting means collects the priority information notified by the other devices;

(S3) Priority information comparison step in which the priority information comparing step compares the priority information of the local device with the collected priority information of the other devices; and

(S4) Wireless communication control step in which as the result of comparison processing in the priority information comparison step, if the priority of the other devices is higher than the priority of the local device, the wireless communication control means controls the wireless communication means to non-operation.

In the priority notification step, it may be so configured such that the priority notification means notifies the priority information to the priority information collecting means of the other devices through the wireless communication network using the same wireless communication means as that used for the communication.

Since the present invention is provided with the priority information in each wireless communication device so that the wireless communication device can compare the priority information with that of the other wireless communication devices, a base station with high priority can perform wireless communication with priority. That is, the wireless communication control means can control the wireless communication means to a non-operation state so that the frequency band can be made available. Also, a frequency of the communication can be reduced so as to avoid trouble in the communication by the wireless communication device with high priority. By providing condition information in the priority information, for example, high and low of the priority can be changed or it can be changed according to the frequency.

With regard to the priority information, according to the configuration in which the notification is made to the priority information collecting means of the other devices using a wireless or wired communication network, the priority information can be exchanged without using a special line between the wireless communication devices. Particularly, by using the wireless communication network through which the wireless communication means communicates, there is no need to provide a special mechanism for exchange of the priority information. The priority information can be autonomously exchanged and compared through the wireless communication between general-purpose access points.

### BRIEF DESCRIPTION OF DRAWINGS

The invention will be described in further detail below and with reference to the attached drawings in which the same or similar elements are referred to by the same number, and where:

FIG. 1 is a configuration diagram of a base station according to the present invention;

FIG. 2 is a flowchart of processing according to the present invention;

FIG. 3 is a configuration diagram of a priority information relay server according to another embodiment of the present invention; and

FIG. 4 is an explanatory diagram illustrating a situation of wireless communication if a plurality of base stations are close to each other.

### DETAILED DESCRIPTION OF THE INVENTION

An embodiment of the present invention will be described below based on examples shown in the figures. The embodiments are not limited to the following.

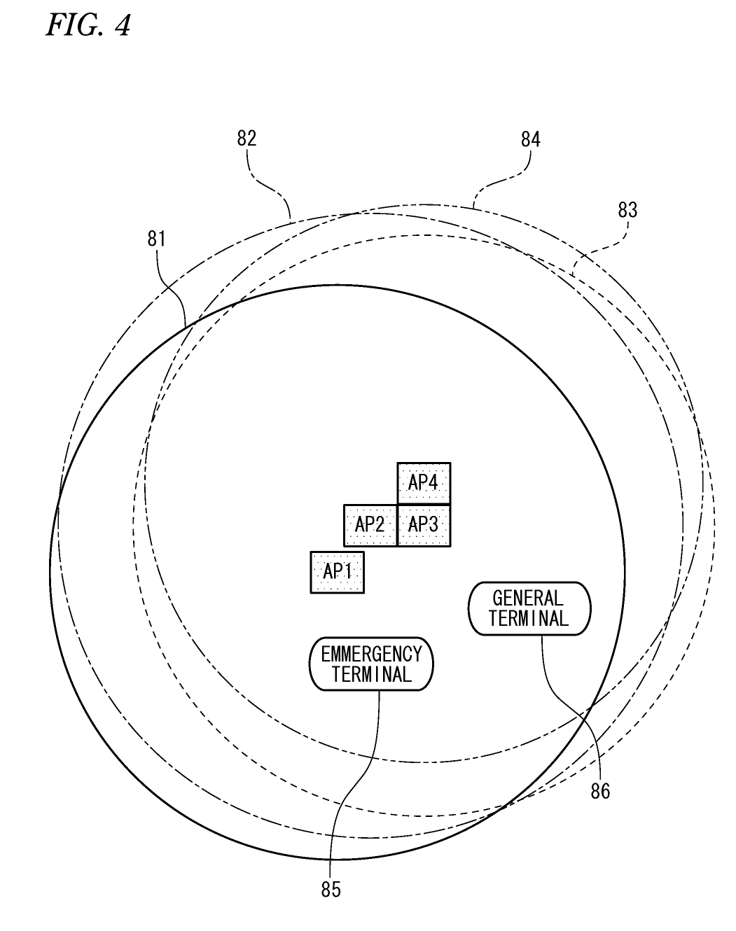

First, an outline of the present invention will be described. In the present invention, a plurality of wireless base stations AP1 to AP4 are arranged in proximity as shown in FIG. 4, and major portions of each communication area ranges (81) to (84) are overlapped. An emergency terminal (85) is also shown in communication with the base station, e.g., AP1 and a general terminal (86) is shown in communication with the base station, e.g., AP4.

In general, a frequency used in a wireless LAN is defined as 2.400 to 2.484 GHz in IEEE802.11b. 1 to 13 channels are allocated in this range, and radio waves might interfere with each other, not only in the case of the same channels, but also in the case of channels close to each other. Therefore, in order to avoid interference, the channels should be set sufficiently separately such as channel 1 for the base station APE channel 5 for the base station AP2, channel 9 for the base station AP3, and channel 13 for the base station AP4.

However, only base stations deployed in a planned manner can be allocated in this manner, and in an environment where the number of base stations is extremely large, the number of channels runs short. A new band such as a 5 GHz band can be allocated, but since the frequency resources are extremely limited, it is impossible to expand them according to demand.

With the past techniques, even if the emergency terminal (85) and the general terminal (86) are mixed, since there is no difference in communication priority between them, there is a fear that a trouble might be caused in communication by the emergency terminal (85) if many users simultaneously start communication at the time of disaster, for example. On the other hand, if a channel is made available all the time for the emergency terminal (85), limited resources cannot be used effectively and unnecessary limitation is applied to the use of the general terminal (86).

In the present invention, a wireless communication system is provided in which priority information of each base station is exchanged among AP1 to AP4, and an operation mode is changed such that if the AP1 is in use by the emergency terminal (85) commences communication, AP2 to AP4, in use by general users, stop communications or the shifts channels so that it does not obstruct the communication by AP1, or allows a communication interval is extended.

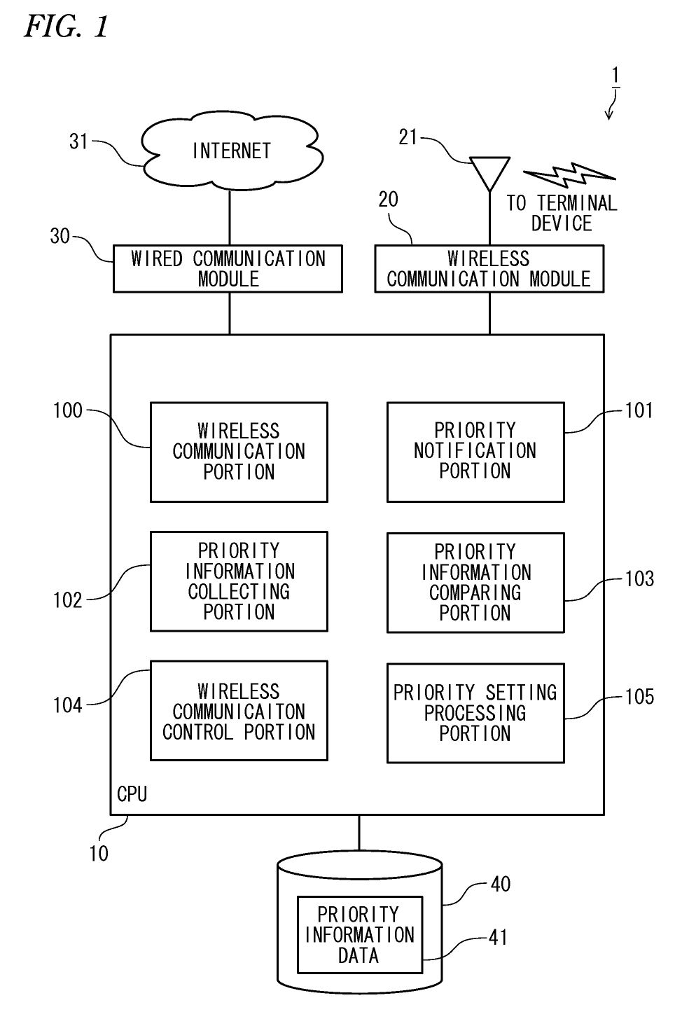

A configuration of such a wireless communication device will be described below. In this embodiment, a base station (access point) of a wireless LAN will be explained as an example of the wireless communication device. FIG. 1 is a configuration diagram of a base station (1) according to the present invention. The base station (1) is a computer device including a CPU (10), a wireless communication module (20) performing wireless communication with a communication terminal, a wired communication module (30) connected to the Internet (31) through a wired network, a non-volatile memory (40), which is memory means, and the like.

As is well known, various models are sold in the market as the wireless LAN base station, and the present invention can be implemented on such hardware. Not limited to the exclusive hardware, the present invention may carried out by a known personal computer, a work station, a server device and the like.

The wireless communication module (20) is attached with an antenna (21). They may be provided in plural in order to communicate with a plurality of wireless communication networks. The wireless communication module (20) is a communication device for connecting with an external network such as a 3G mobile phone line network, PHS, Bluetooth® and the like, in addition to the wireless LAN, and offered in various modes such as a CF card, a PCI card and the like.

Also, a known software modem technique may be implemented in the CPU (10) in order to deal with the plural types of wireless networks, and in that case, the hardware can be used in common. The base station (1) is capable of wireless communication with a communication terminal by a wireless communication portion (100) as is well known.

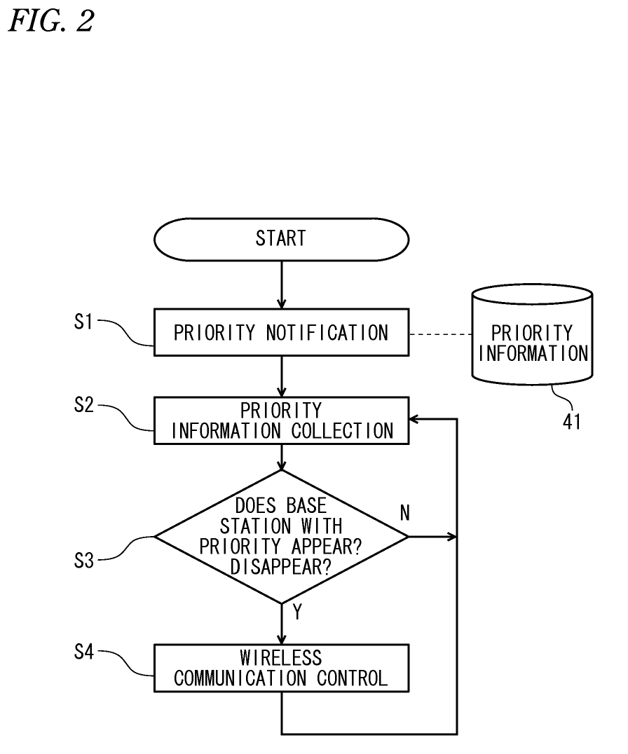

Processing of the present invention is shown in the flowchart of FIG. 2 in conjunction with the configuration diagram of FIG. 1. First, a priority notification portion (101) of the CPU (10) transmits priority information of the terminal to another base station. The priority information is stored in a memory (40) as data of priority information (41). Here, the priority is a value for determining a priority order in a relationship with other base stations. In a simple example, the priority can be stored in an absolute evaluation value in five levels such that the highest priority is 1 and the lowest is 5. Such priority information (41) can be defined as non-rewritable information at the time of manufacture of the base station. The priority can also be defined according to other predetermined conditions as described further herein.

The priority information can be given by any of the following methods besides manufacture of the base stations (1) with the specified values defined.

First, a priority setting processing portion (105) is provided in the base station (1) so that a user can directly set the priority information (41). A known web server function can be provided at the base station for setting of the base station from a web browser on the terminal. In the present invention it may also be configured such that the priority information can be set as appropriate on a similar setting screen.

In this configuration, since the user can arbitrarily set the priority information in facilities such as a business concern or school, for example, priorities can be given to base stations to be installed such that if one of base stations is to be used, the other base stations stop communication. As a specific example, there can be such a case that while the wireless communication service is being provided to guests, the service opened for the customers is lowered if important communication for service is required.

Second, there is a method in which by inputting non-alterable information provided by an administrator administering the priority, where the priority is determined by the administrator and is set. In this method, administrators are divided into two levels, that is, an administrator managing a single base station and an administrator managing the priority in a centralized manner. Accordingly, the administrator of a particular base station receives delivery of coded priority information from the administrator of priority and sets the priority by inputting it in that base station. In order to employ this method, the priority setting processing portion (105) is provided with a decoding processing function at the base station (1) in advance, and priority information is calculated from the decoded information. This information is stored as the priority information (41). Since the setting information has been coded, the administrator of a base station cannot arbitrarily make setting, which contributes to appropriate management of the priority.

Third, a reading interface (not shown) of a recording medium such as a USB memory, a CompactFlash™ and the like is disposed in the base station (1) so that the priority setting processing portion (105) can store the priority information (41) on the basis of the setting information stored in the recording medium. As mentioned above, by enabling setting of the priority information only by the recording medium, which is hardware, the recording medium is managed and rewriting of the priority information is prevented so that appropriate management can be realized easily.

Fourth, the system can be configured such that an administrator remotely sets priority through a communication interface. With the first method, the configuration in which setting is made from a terminal device was explained, but in this method, an administrator of the priority remotely sets the priority from an external terminal connected through an external network such as the Internet (31). This method is suitable for setting the priority information of a plurality of base stations in a centralized manner and contributes to appropriate management since only the administrator of the priority with authority can make the setting.

For setting the priority, arbitrary methods other than the above can be used, and the above methods may be combined for setting the priority.

The priority information (41) stored in advance or set as above is notified by the priority notification portion (101) to the other base stations, indicated in FIG. 2 as priority notification step (S1).

The notification method will be described. The simplest method is direct transmission from the wired communication module (30) through the Internet (31) to a priority information collecting portion (102) of another base station. IP addresses of the other base stations or the like are stored in advance, and the information is transmitted to the address. Alternatively, notification may be made to all the base stations connected to a node which is one level higher.

Similarly, the priority can be directly notified from the wireless communication module (20) to the other base stations. Also, the wireless communication module (20) can scan the base stations around it and notify the priority to all the base stations that can be detected.

In the present invention, another communication means connected in a wired or wireless manner for notifying the priority may be provided other than the above. However, if the notification is directly made to other base stations using the wireless communication network capable of communication with the wireless communication module (20) as mentioned above and the notification can be received, usability of the base station (1) is improved. That is, if the base station (1) is to be sold as a product, only by providing the function of the present invention and by unifying a notification method of the priority, exchange of the priority information is realized. The most distinguished characteristic of the present invention is that, regardless of a manufacturer of the base station or an installer of existing base stations, only by installing corresponding base stations (1), the priority can be automatically exchanged with the base stations (1) around it, and the frequency resources can be effectively used.

Data formats of transmission or paths are arbitrary in the notification method of the priority, and the following methods, for example, can be employed.

First, information indicating the priority can be added into the data frame transmitted by the base station. The priority information collecting portions of the other base stations receive the data frame and extract the priority.

Another method is that a channel dedicated for common signaling is prepared, and when the base station performing wireless communication starts communication or with a predetermined interval, a beacon is transmitted through the dedicated channel. The priority information collecting portions of the other base stations monitor the dedicated channel at all times. As a dedicated channel, a channel 14 of the wireless LAN can be used in one embodiment.

If the priority information collecting portion (102) receives the priority information from another base station, indicated at step (S2) in FIG. 2 (priority information collecting step), a priority information comparison portion (103) compares the priority information (41) of the base station with the received priority information, as indicated at step S3 (priority information comparison step). For example, if the priority of the local station has an evaluation value of 3 in the 5-level evaluation with 1 as the highest and the priority information of another station has an evaluation value of 2, it is determined that the priority of the other station is higher.

If it is detected that a base station with higher priority newly appears, the wireless communication control portion (104) performs communication control for the wireless communication module (20), indicated at step S4 of FIG. 2 (wireless communication control step).

As the communication control, there can be a change in the operation mode such that the wireless communication (transmission of radio wave) is stopped, the number of transmissions of packets per time is reduced in the wireless communication, radio-wave transmission is made intermittent, the frequency in use is changed, and the like.

As mentioned above, if communication is conducted using a proximate frequencies, there is a concern that the wireless communication with higher priority is obstructed by radio wave interference. Thus, if a base station with higher priority is detected, the wireless communication module can be stop-controlled so as to stop transmission of a radio wave.

Also, if a large quantity of packets are transmitted, traffic becomes crowded and communication traffic of the communication with higher priority is limited. Thus, control may be executed such that the transmission amount of the packets is decreased. If a voice call or the like is conducted in the wireless communication with priority, the call quality can be improved by this processing.

If transmission of a radio wave is completely stopped, the base station can no longer conduct its own communication, and thus, stop/resumption of the wireless communication module may be repeated intermittently. Control to intermittently operate the module is executed, for instance, such that the module is shut off for time of 8 parts, connected for time of 2 parts, and shut off again for time of 8 parts for the communication of the base station with priority.

Moreover, a channel used by the wireless communication module (20) may be switched. In this case, the received priority information and a channel of the base station that can be detected by the wireless communication module are obtained, and the frequency of the local station is changed to a channel far from that channel. It may be so configured that a channel number in use is notified by the priority notification portion (101) and the channel number is collected by the priority information collecting portion (102) together with the priority information. If the frequency of the local station is changed and the terminal device needs to follow it, the channel number to be changed may be notified to the terminal device from the base station (1) using a channel in use in the data communication. Alternatively, the notification may be made using the dedicated channel for common signaling.

The priority information comparison portion (103) detects if there has been any change since the priority information was collected last time. That is, if the base station with the priority of 3 was also detected at the previous collection with respect to the local station with the priority of 2, since the wireless communication of the local station has been already controlled, there is no need to execute wireless communication control (S4) again, but it is only necessary that the priority information collection processing (S2) is repeated.

Therefore, history information regarding the priority information on which base station was collected at the priority information collecting step (S2) is stored, and only if a base station different from the base station in the history appears or disappears, the priority information comparison portion (103) executes the comparison processing (S3).

Contrary to the above, if the base station with the priority of 2 disappears (stops operation) after the local station with the priority of 3 executes the wireless communication control (S4), the wireless communication control portion (104) executes the communication control processing again. That is, if the wireless communication has been stopped, the communication is resumed, and if the transmission amount of packets has been decreased, the limitation is cancelled. If the wireless communication has been operated intermittently, continuous communication is resumed. If the frequency has been changed, and if it is necessary to return to the original channel, the return may be made; alternatively, if the frequency in inconsequential, there is no particular need to change the channel.

If another base station with higher priority starts wireless communication, the present invention having the above configuration autonomously changes the mode of the wireless communication of the local station by comparing the priority information transmitted from the base station and the priority information (41) of the local station. Radio wave transmission is stopped or a channel is made available so that quality of the wireless communication of the base station with priority is not damaged. If the base station with priority stops communication, the communication is automatically resumed so that the local station can conduct wireless communication again, and the frequency resources can be utilized at the maximum.

Conditions may be set for the priority information (41). Several examples will be shown.

First, priority can be given to each frequency. For example, with regard to a base station (1), channels that can be used with priority are allocated to each base station such that the priority is 4 if channels 1 to 4 are used, the priority is 3 if channels 5 to 9 are used, the priority is 2 if the channels 10 to 13 are used and the like.

Then, by notifying the condition information as above along with the priority information (41), the base station having received it obtains the priority according to the channel used by that station. If the receiving base station is using the channel 5, for example, the comparison processing (S3) is executed with the priority of the counterpart as 3 from the collected result. With the above configuration, an emergency channel is determined in advance, for example, so that a base station that can use the channel with priority can be determined.

Also, by defining a channel with priority for each group, each group can use the channel with priority, while the other bands can be utilized when other groups are not using it. As a result, the frequency resources can be effectively used.

Subsequently, time information such as date, time, day of the week and the like can be included in the condition information. In this case, a clocking portion (not shown) is provided in the base station (1). It may be so set that the priority of a base station for business operation is raised during business hours, while the priority is not given for the time other than that. It becomes possible to make setting such that the wireless communication of a specific base station is given priority only for specific dates or days.

Also, the priority can be raised within a predetermined time by measuring communication duration. That is, the wireless communication of a base station used by users for a short time is given priority, while use of the base station is limited if the time of use is extended so that fair service can be provided to the users.

The base station (1) of the present invention is not limited to a fixed base station but may be configured as a mobile station. Portable access points in the wireless LAN have already widely spread. In this case, a terminal position may be used for the condition information. A GPS processing portion (not shown) is provided at the base station (1), and a current position of the base station (1) is measured by global satellite positioning. Then, the priority of the local station can be changed according to the position. For example, the priority is raised if the station is installed in a local office, while the priority can be set lower outside the office so that the communication of the others is not badly affected.

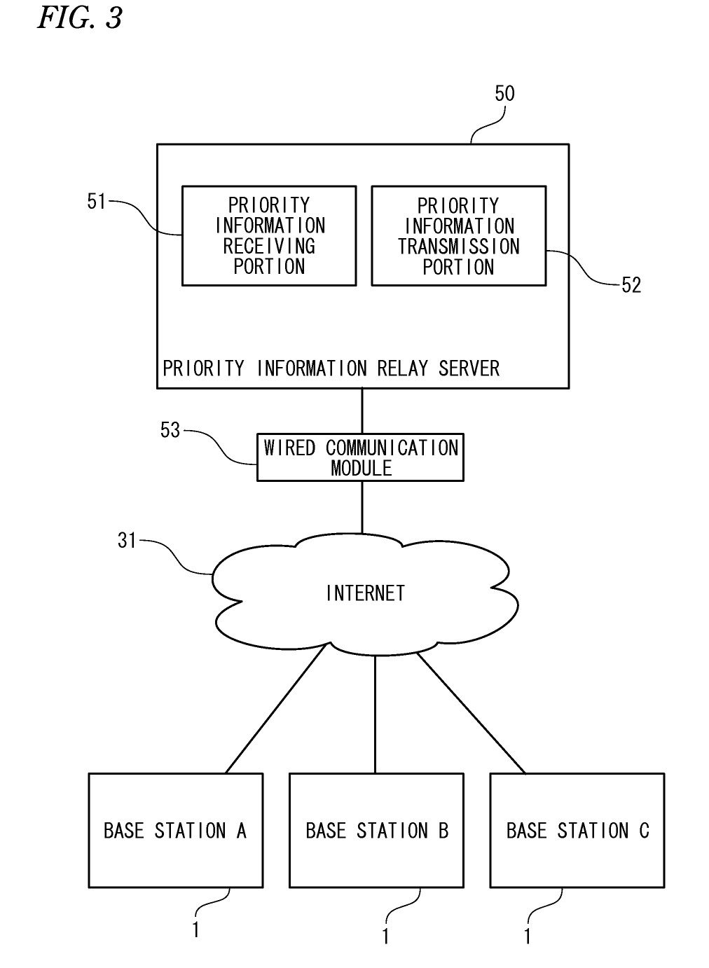

In another embodiment of the present invention, a relay server for relaying the priority information (41) on the Internet (31) or the like can be provided in order to exchange the priority information (41) among the base stations. This configuration is shown in FIG. 3. A priority information relay server (50) receives the priority information (41) from the plurality of base stations (1), (1), (1) through the Internet (31). That is, the priority information (41) is received by the priority information receiving portion (51) through a wired communication module (53). The received information is transmitted as it is from the priority information transmission portion (52) to each of the connected base stations (1), (1), (1).

In this configuration, since what base stations are present can be grasped by the priority information relay server (50) in a centralized manner, there is no need that each base station scans the other base stations or is provided with means in advance. Also, a base station detection portion, not shown, may be provided in the priority information relay server (50) so that a change in the existing base stations can be detected. With this configuration, since the server (50) can detect the case in which the priority order might be changed, the number of priority information exchange times can be reduced, and a load on each base station (1) can be reduced.

The example in which the wireless communication device is a base station has been described as an embodiment of the present invention, but the present invention can be also applied to femtocell, which is a small-sized base station of a mobile phone, a sensor node performing ad hoc communication and the like, and the type of the wireless communication device does not matter.

The methods and system of the present invention has been described above and in the attached drawings; however, modifications will be apparent to those of ordinary skill in the art and the scope of protection for the invention is to be defined by the claims that follow.

We claim:

1. A wireless communication device used for communication through a wireless communication network, comprising at least:
wireless communication means;
priority information memory means storing priority information of the communication conducted by a local device;
priority notifying means notifying the priority information to other wireless communication devices;
priority information collecting means collecting the priority information notified by the other devices;
priority information comparing means comparing the priority information of the local device with the collected priority information of the other devices; and
wireless communication control means controlling an operation mode of the wireless communication means of the local device,
wherein as the result of comparison processing by the priority information comparing means, if the priority of the other devices is higher than the priority of the local device, the wireless communication control means controls the wireless communication means to non-operation or a communication state with a low load.

2. The wireless communication device according to claim 1, wherein
in the wireless communication device, the priority information is provided with condition information regarding the priority; and
the priority information comparing means compares the priority information on the basis of satisfaction or not of the condition according to the condition information.

3. The wireless communication device according to claim 2, wherein
the condition information defines the priority according to a frequency at which the wireless communication is conducted.

4. The wireless communication device according to claim 2, wherein
the wireless communication device is provided with clocking means; and
the condition information defines the priority according to time information such as date, time, day of the week, operation lasting time and the like.

5. The wireless communication device according claim 1, wherein
the priority notifying means notifies the priority information to the priority information collecting means of the other devices using a wireless or wired communication network.

6. The wireless communication device according to claim 5, wherein
the priority notifying means notifies the priority information to the priority information collecting means of the other devices from the wireless communication means through the wireless communication network.

7. The wireless communication device according to any one of claims 1, wherein
the priority notifying means makes notification by adding the priority information to a data frame transmitted from the wireless communication means; and
the priority information collecting means receives the data frame transmitted from the wireless communication means of the other devices and extracts the priority information.

8. A wireless communication system including a wireless communication network and a plurality of wireless communication devices, the wireless communication device comprising at least:
wireless communication means;
priority information memory means storing priority information of the communication conducted by a local device;
priority notifying means notifying the priority information to other wireless communication devices;
priority information collecting means collecting the priority information notified by the other devices;
priority information comparing means comparing the priority information of the local device with the collected priority information of the other devices; and
wireless communication control means controlling an operation mode of the wireless communication means of the local device,
wherein as the result of comparison processing by the priority information comparing means, if the priority of the other devices is higher than the priority of the local device, the wireless communication control means controls the wireless communication means to non-operation or a communication state with a low load.

9. The wireless communication system according to claim 8, further comprising
a priority information relay server which collects the priority information from the priority notifying means of the plurality of wireless communication devices and notifies the collected priority information to the plurality of wireless communication devices.

10. The wireless communication system according to claim 8, wherein
the priority notifying means notifies the priority information to the priority information collecting means of the other devices from the wireless communication means through the wireless communication network.

11. A method of wireless communication in a wireless communication system including a wireless communication network and a plurality of wireless communication devices, in which an operation mode of wireless communication performed by each device can be adjusted between the wireless communication devices, and priority information of the communication conducted by the local device is stored in the wireless communication device in advance, the method comprising:
a step of priority notification in which priority notifying means notifies the priority information of the local device to the other wireless communication devices at a predetermined trigger;
a step of priority information collection in which priority information collecting means collects the priority information notified by the other devices;
a step of priority information comparison in which priority information comparing means compares the priority information of the local device with the collected priority information of the other devices; and
a step of wireless communication control in which as the result of comparison processing at the priority information comparing step, if the priority of other devices is higher than the priority of the local device, wireless communication control means controls wireless communication means to non-operation or a communication state with a low load.

12. The wireless communication method according to claim 11, wherein
at the step of priority notification in the wireless communication method, the priority notifying means notifies the priority information to the priority information collecting means of the other devices from the wireless communication means through the wireless communication network.
